(19) United States
(12) Patent Application Publication
(10) Pub. No.: US 2018/0174264 A1
(43) Pub. Date: Jun. 21, 2018

(54) APPARATUS, MEANS OF TRANSPORT AND METHOD FOR ASSISTING A USER IN A COMMON USE OF A MEANS OF TRANSPORTATION

(71) Applicant: VOLKSWAGEN AG, Wolfsburg (DE)

(72) Inventors: Gregor STOCK, Wolfsburg (DE); Simon KARRENBERG, Braunschweig (DE); Marianna RECCHIA, Berlin (DE)

(21) Appl. No.: 15/844,518

(22) Filed: Dec. 16, 2017

(30) Foreign Application Priority Data
Dec. 16, 2016 (DE) 10 2016 225 285.2

(51) Int. Cl. G06Q 50/30; G06Q 30/06; G07B 15/02

(52) U.S. Cl. CPC G06Q 50/30; G06Q 30/0645; G06Q 30/0609; G07B 15/02; H04W 4/04

(57) ABSTRACT

A device, transportation vehicle and method for assisting a primary user when transportation vehicle is used by other users. The method includes receiving a request to rent transportation vehicle from a first user, reading out a contract-related attribute for the first user based on membership of the first user of a user group, and concluding a digital rental contract between the primary user and the first user by using the attribute of the user group.

### PRIORITY CLAIM

This patent application claims priority to German Patent Application No. 10 2016 225 285.2, filed 16 Dec. 2016, the disclosure of which is incorporated herein by reference in its entirety.

### SUMMARY

Illustrative embodiments relate to a device, transportation vehicle, and a method for assisting a primary user when transportation vehicle is used by other users. Disclosed embodiments relate to a comfortable way for a primary user's own a transportation vehicle to be used by family members and/or friends under different conditions than by less-known persons or completely unknown persons.

### BRIEF DESCRIPTION OF THE DRAWINGS

The disclosed embodiments are described below with reference to the appended figures in the drawings.

FIG. 1 shows a schematic illustration of a situation of transportation which is to be used jointly;

FIG. 2 shows an exemplary embodiment of a disclosed device; and

FIG. 3 shows a flow chart illustrating operations of an exemplary embodiment of a disclosed method.

### DETAILED DESCRIPTION

The demand for new mobility concepts is arising as a result of trends such as urbanization, digitization or the readiness for greater sharing of products and services. The sharing between private individuals is experiencing rapid growth which takes the form, for example, of so-called Peer-to-Peer services such as Airbnb, Uber, Lendingclub, etc.

DE 10 2011 082 982 A1 discloses a method for the computer-supported administration of vehicles in which a vehicle is authorized by abled persons for temporary use by the owner of the vehicle in a computer-assisted state within the scope of a predefined price model. A business area comprises one or more delimited areas in which the vehicle has to be parked after the temporary use has ended.

US 2002/0010602 A1 discloses a method for the individual lending of a private vehicle in which user information is fed to a server of the keeper via a terminal of the keeper. Availability information provides the closest person wishing to rent a vehicle with information about where the vehicle is located.

The trends described above are also already being felt as changed user requirements in respect of individual mobility. The occupants of cities desire convenient access to flexible mobility in their immediate surroundings and at the lowest possible cost. As a result, for many city dwellers the idea of owning their own vehicle is becoming less and less attractive owing to various factors such as lack of parking space, high fixed costs with a low utilization rate and a wide range of alternative mobility offers, as a result of which, for reasons of convenience and/or cost, people are not (newly) acquiring a vehicle. To increase the attractiveness of the ownership of a car particularly in inner-city areas, currently concepts are known which permit common use of vehicles (car sharing) even for private vehicles. However, many primary users have a high level of reluctance to allow unknown persons to access their transportation vehicle. Even if renting out their own vehicle would provide attractive income or sharing of fixed costs, the risks in terms of damage/soiling of their transportation vehicle are so serious that many primary users do not take upon themselves the effort involved in concluding a contract in paper form with potential hiring parties/users of the vehicle. There are usually fewer emotional hurdles for vehicle owners in allowing a vehicle to be used by friends or relatives. Nevertheless, there is a lack of clear boundary conditions for such a hiring arrangement, in particular with respect to the risk of damage and the assumption of costs. Disclosed embodiments meet the demand which has been identified above.

This is achieved by a device, transportation vehicle, and a method for assisting a primary user (e.g., a keeper, an owner or the like) when a transportation vehicle is used by other users. The primary user and the other user can have different relationships with one another in this context: they can be unknown to one another, be friends or be related or the like. The transportation vehicle can be a passenger car, transporter, truck, motor cycle, aircraft and/or watercraft. The method comprises receiving a request to rent a transportation vehicle from a first potential user. This can be carried out, for example, by an application on a smartphone, a tablet or the like. In other words, the primary user and the user can communicate by an app, a computer program or the like to exchange the request. Location-based information can be exchanged in so doing, which offers a comfortable hiring arrangement and the best possible information situation about the availability of the transportation vehicle. Subsequently, a contract-related attribute for the first user is read out on the basis of membership of the first user of a user group. In other words, the primary user has already assigned the first user in advance to a predefined user group (e.g., within his app). The user groups can be assigned, for example, to a family circle, a group of colleagues, a group of friends and other (known or unknown) users. The contract-related attribute is to be understood here as meaning that it defines conditions of the rental contract to be concluded for the use of the transportation vehicle by the first user. In other words, on the basis of different attributes for the user groups when a request to rent a transportation vehicle is accepted by the primary user a different type of rental contract is concluded with members of a first user group than in the case in which the requesting user belongs to another predefined user group. Subsequently, a rental contract is concluded between the primary user and the first user by using the attribute of the user group in that the primary user confirms the request and as a result allows the rental contract to come about. The rental contract can be understood as being a demand-based rental contract which can be the subject matter of a framework contract between the primary user and the first user. The framework contract may also have been concluded with a third entity (for example. supplier of the app, intermediary). The automatic use of the contract-related attributes of the user group when concluding the contract for the use of a vehicle between the primary user and the first user as a function of membership of the user of a user group simplifies the configuration of the use-based rental contracts and increases the readiness of the primary user to make available his transportation vehicle for the common use by other users. The rental arrangement is also less complicated for potential users of the transportation vehicle. However, in all cases the potential users will be able to estimate the boundary conditions which are clear and favorable to them and which offers them a digital rental contract within the scope of a professionally configured rental platform.

The primary user can combine predefined users of a transportation vehicle into user groups, wherein the users may, for example, have already been created in advance on the user terminal which is used for this purpose. For example, the primary user can firstly provide user groups with attributes and subsequently add users to respective user groups. Alternatively or additionally, the primary user can combine users to form a user group and subsequently define attributes for the user groups or adapt them (in response to experiences with the disclosed method) insofar as such a requirement has come about.

For example. the validity of traffic liability insurance (of the primary user or of the user) during the use of the transportation vehicle by the first user can be defined as contract-related attributes (also referred to as “clauses in the contract”). In other words, the contract-related attribute can define whether when the transportation vehicle is rented by the first user the traffic liability insurance of the primary user or that of the user is to be applicable in the event of damage. Correspondingly (independently of the validity of the traffic liability insurance) a charge as a contribution by the first user to the costs arising from the use of the transportation vehicle can be defined. It is also possible to make available the transportation vehicle without charge (e.g., for family members and good friends). Alternatively or additionally, it is possible for the state in which an energy accumulator of the transportation vehicle has to be if the transportation vehicle is transferred to the first user or to the primary user to be defined as a contract-related attribute. A filling level of the energy accumulator can be prescribed or left open. Alternatively or additionally, an obligation or discharge of the first user with respect to the establishment or restoration of an agreed transfer state can be defined. In other words, the first user can be obliged to return the transportation vehicle in a clean state. Since the abovementioned contract-related attributes may have been formulated by a professional entity (e.g., the supplier of the application), the primary user's trust and that of the first user in the validity of the rental contract increase, even though the primary user can activate or deactivate the respective attributes or, if appropriate, configure them within secure boundaries by selecting a parameter (costs as a percentage, filling level of the fuel tank as a percentage or the like).

To be able to further reduce the hurdles for entry into participation in the disclosed method, after the installation of a corresponding application on a terminal of a primary user (the same applies to the first user), a request can be output, with which the primary user or the first user is requested to import his consent to the importing of personal contacts (e.g., from a personal address book in the terminal of the primary user or in a cloud) into a circle of potential users of his transportation vehicle (the potential persons known to his application). In this context, the primary user can release certain address books, groups of the address books or contacts provided with predefined contact attributes for importing by the application.

Corresponding contact attributes which are stored in the address book can be used for an assignment of the contacts to one or more user groups. For example, a membership (of a family, of a company, of an academic year or the like) can be used to make a (first) assignment of the contacts to the user groups. For example, it is also possible to use attributes, which in modern address book entries of individual contacts (as “father”, “mother”, “sister”, “partner”, “brother-in-law”, “brother of brother-in-law” or the like) to automatically bring about membership of a “family” user group. This makes it easier for the primary user and the first user to set up the application and increases its acceptance.

The user can intentionally, for example, with a click, make his vehicle publicly visible, and deactivate it again, and therefore permit the outputting of requests of an unlimited or of a limited user circle. This has the benefit that the primary user/keeper would, under certain circumstances, like to share (and needs to share) his vehicle only with persons who he knows. He can then invite these persons to use his vehicle.

According to a second disclosed embodiment (“rental-arrangement-based insurance contractual period”), it is proposed to start an insurance contractual period of traffic liability insurance in the name of a first user only when a risk transfer to the first user has been confirmed, and to end it again immediately after a renewed transfer of risk of the transportation vehicle to the primary user/keeper/owner. For this purpose, a framework contract can be concluded in advance between the first user and an insurance company and/or between the primary user and an insurance company, which framework contract regulates the framework conditions for a rental-arrangement-based transfer of risk in respect of traffic liability.

The embodiment mentioned above of the rental-arrangement-based contractual period can expand the first-mentioned embodiment of the disclosed method for assisting the primary user when a transportation vehicle is used by other users. In a further operation, a transfer of risk from the primary user to the first user with respect to the transportation vehicle is therefore confirmed. This can be done, for example, by the primary user accepting the request of the first user. This can be done by activation of a corresponding button on a display of a terminal of a primary user (e.g., smartphone, tablet or the like). In response to the confirmation of the transfer of risk, the contractual period of the rental-arrangement-based traffic liability insurance is started automatically. The start of the contractual period can be stored, for example, in the terminal, in a terminal of the primary user, and in the terminal of the first user and alternatively or additionally in a data storage mechanism of the transportation vehicle. Alternatively or additionally, an independent entity can log the start of the contractual period. In other words, the confirmation of the transfer of risk can cause a message to be sent to a trustee, to the insurance company and/or to a manufacturer/provider of the app which is being used, and to be stored in a data memory, in particular with a precise time of day, a date and, if appropriate, position information about the locations of the primary user/of the first user/of the transportation vehicle when the contract is concluded/risk is transferred. In this way, in a case of damage, the start of the contractual period and therefore the responsibility of the traffic liability insurance of the first user may be documented at different locations (in particular, outside the possibly written-off transportation vehicle). In the case of damage, the traffic liability insurance of the primary user is then no longer required to cover (partially) the costs arising from, for example, an increase in the insurance premiums which have to be paid by the primary user. On the other hand, the first user has the good feeling that a “fair” settlement of the damage has been arrived at without any financial loss for the primary user, who is not responsible for the case of damage, and without being able to simply reimburse the primary user for the (vague) costs of increased insurance premiums.

In a corresponding way, when a transfer of risk from the first user back to the primary user is confirmed, the end of the contractual period of the traffic liability insurance can be documented in the name of the first user. In this context, the processes clearly correspond to those for the documentation of the start of the contractual period in such a way that reference is made to the statements above to avoid repetitions.

According to a third disclosed embodiment, a device for assisting a primary user when a transportation vehicle is used by other users is proposed. The device can be configured, for example, as a smartphone and/or as an electronic control unit of a transportation vehicle or for a transportation vehicle. The device comprises at least a receiver device (e.g., an antenna, a wireless communication module or the like) and an evaluation unit which can be configured, for example, as a programmable processor, as a microcontroller and/or as an electronic control unit or the like. The receiver device is configured to receive a request to rent a transportation vehicle from a first user. The evaluation unit is configured to read out a contract-related attribute for the first user on the basis of a membership of the first user of a user group. Subsequently, a digital rental contract is concluded between the primary user and the first user using the contract-related attribute of the user group. The features and feature combinations of the disclosed device resulting therefrom are clearly apparent from those which have been stated in conjunction with the disclosed methods, and therefore reference is made to the statements above to avoid repetitions.

According to a fourth disclosed embodiment, a transportation vehicle (e.g., a passenger car, transporter, truck, motor cycle, aircraft and/or watercraft) is proposed which comprises a device according to the third disclosed embodiment. The transportation vehicle can belong to a private and/or a commercial primary user (e.g., pool car/fleet vehicle) or can be kept thereby. The transportation can have the device ex works (permanently integrated into an on-board power and information system). In this context, a screen (e.g., a combination instrument, a central information screen (CID) or the like) can be used as a primary user interface. Alternatively or additionally, the transportation vehicle can be logically linked to a smartphone, a tablet or some other wireless communications terminal of the primary user, to carry out the operations of a disclosed method according to the first-mentioned embodiment.

One idea is to use a digital platform to provide private users with the possibility of being able to share their own vehicle conveniently, easily and securely with other private users. However, known approaches address customer requirements incompletely and not satisfactorily. The disclosed approach permits a differentiation with respect to existing concepts (other providers of car-sharing applications or vehicle manufacturers). In contrast to existing concepts, the disclosed embodiments consider not only rental processes with unknown persons or third parties for payment but also rental processes within the family, with friends, acquaintances or neighbors as well as with other persons and these are suitably regulated on an individual basis. As a further difference it is proposed to represent the entire rental process in a completely digital state (e.g., by a mobile application platform). The operations extend from matchmaking, reserving and finding the vehicle to insurance and accessing the vehicle, and to the use and return of the vehicle. As a result, both the functions of the party renting out a vehicle as well as those of a potential renter are disclosed. In this respect, for example, an application case of the proposed service is described, in which the keeper of the transportation vehicle logs into an application, invites the renter, and the latter rents the vehicle of the keeper and subsequently uses it.

Initially, the keeper logs into his application. Subsequently, various functions are available for him to select. In the user profile, the user can see the evaluations. The evaluations can refer to his person and/or to the transportation vehicle made available by him. In addition, an on-line identification process can be performed, more details of which will be given with respect to the renter functions. The vehicle profile offers the possibility of seeing attributes of the vehicle such as power, number of seats etc. With one click the primary user can establish the public visibility of his vehicle and therefore permit requests of an unrestricted or of a restricted user circle to be output. This has the benefit that the keeper would possibly like to (and needs to) share his vehicle only with persons who he knows. He can then invite these persons to use his vehicle.

The vehicle can be opened or closed by a predefined primary user input (e.g., a swiping gesture). The position of the vehicle and the position of the person in question can be seen on a map of the application. In addition, route guidance from the position of the person in question to the vehicle can be started. Individual operator control elements permit the vehicle to be transferred (only necessary for a potential user) to make it possible to navigate to the vehicle, to cause the vehicle to output a signal once (flashing, turning up the headlights, sounding the horn or the like), to interrogate the vehicle status (e.g., energy supply, oil level), to cause the damage log to be displayed or to cause the inventory (the equipment information) of the vehicle to be displayed.

In addition to the above mentioned functions, configurations and administration actions can be executed. By individual operator control elements the person's own profile can be changed, the calendar can be viewed, general settings can be made, favorites can be defined, the person's own vehicle or allows vehicles can be managed, the rental profiles of the vehicles can be managed or AGB can be viewed. By an “invitation function”, the disclosed application allows explicit permission to be granted to selected users to rent the vehicle in question when necessary. In combination with the above-described function of the ability to see the vehicle, this increases the motivation of the primary user to offer his transportation vehicle in principle by the disclosed method. In response to positive experiences with well known and less well known users, the keeper/primary user is additionally encouraged to make available the transportation vehicle to largely or entirely unknown potential users. As a result, the potential user receives an invitation which he can receive or reject. By a search function, a potential user can also keep an eye out for vehicles for rent. There are various options for this: the first possibility consists in being able to freely browse for vehicles in his own surroundings. The second option permits a search for vehicles in the vicinity in a map-based state, and the third possibility consists in searching for and displaying vehicles at a specific time at a predefined location in a list-based state. By a chat function, the potential user can communicate directly with other users or with the primary user in the proposed app. In an inbox, the user/primary user receives messages of an official character such as, e.g., booking requests or messages from the operator (the application or the service. The renter receives from the keeper an invitation via an SMS or email via his app (or via some other protocol) as described above, and can then download the service or the app. The service or the app can also be loaded from an app store. The potential user subsequently starts with the log-in as described above, in a way corresponding to the primary user. In this context, it may be necessary for the user initially to create an account and prove his identity. For example, this may require a Postident procedure to check the trustworthiness of the primary user and his insurability. After successful registration, the user also arrives at a start screen. Since the user is not linked to a vehicle, there is also no vehicle represented on the start screen. In his inbox, the user then finds the invitation of the vehicle keeper/primary user with the associated conditions relating to insurance and rental price which the renter can accept or ignore. The conditions can be understood to be insurance-related attributes (see above) which the primary user has defined on the basis of the association of the user with a user group. If the user then accepts the invitation, he can see the vehicle in a corresponding booking menu. The user can then make a booking request to the primary user by firstly selecting the vehicle and then confirming his selection. A window then appears which permits the user to define the start point and the end point of the rental arrangement. He can then make the booking request which is subsequently transferred to the primary user. If the latter consents to the request, the requested vehicle and confirmation of the rental data (possibly modified by the primary user) then appears on the user's start screen. The renter can then see the vehicle, but not yet use it. For this he must first execute a transfer process. This transfer process can comprise the above-described use-time-period-based insurance contract for the user of the vehicle for the rental period. The insured party for the vehicle in the rental time period is then no longer the vehicle keeper but rather the vehicle user (first user). To transfer the vehicle, the user can then proceed, for example, as follows: the user actuates a button to assume the risk for the undamaged state of the vehicle (transfer of risk). A screen for the transfer of the vehicle then appears. In this screen, the renter must confirm that he has a valid driving license, that he accepts the damage log and the present condition of the vehicle and confirms the inventory which is possibly present. Only if all the points specified above have been accepted can the user transfer the vehicle. As a result, the user must explicitly confirm the input by a password/fingerprint. If he does this, the insurance contract is activated and the user is given access to the requested vehicle. The user can then open the vehicle and use it. In contrast, the primary user no longer has access to the vehicle. If the user no longer requires or has to give up the vehicle, he uses a corresponding menu again to initiate the renewed risk transfer to the primary user. The user subsequently sees an overview of all the relevant data relating to his rental arrangement. If he wishes to end the rental procedure, he can give up the vehicle with a primary user interaction, and the vehicle is subsequently made available again to the primary user. If appropriate, the user must also provide confirmation here by a password/fingerprint. In contrast, the user no longer has access to the vehicle, and the rental procedure is terminated.

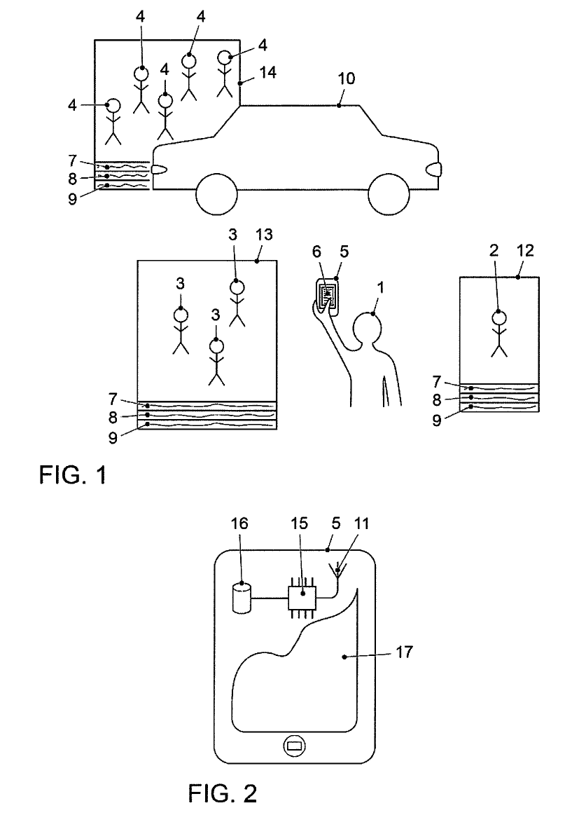

FIG. 1 shows a keeper 1 as a primary user of a passenger car 10 of a transport, which keeper 1 is holding in his hand a smartphone 5 as an exemplary embodiment of a device according to the disclosure. In the smartphone 5, the keeper 1 has assigned his partner 2 as first user to a first user group 12 with attributes 7, 8, 9, to permit his partner 2 to have essentially unconditioned use of the passenger car 10 without charge, at the insurance risk of the keeper 1. As a further user group the keepers' circle of friends 13 comprises three persons 3 as users who use the traffic liability insurance of the keeper 1 and are absolved of cleaning obligations after the end of the rental arrangement. However, the persons 3 in the circle of friends 13 are obliged to assume costs (energy, wear and tear etc.) which arise for the keeper 1. In contrast, persons 4 are assigned to another user group 14 which the keeper 1 wishes to contribute not only to the costs incurred but also to the fixed costs, by a contract 6. Corresponding user attributes 7, 8, 9 define, for all the members of the respective user groups 12, 13, 14, clauses of the rental contract 6 which is to be concluded in a digital state.

FIG. 2 shows a schematic illustration of a smartphone 5 which is configured according to the disclosure as a device which shows a touchscreen 17 in a partially cut-away illustration. Behind the touchscreen 17, an antenna 11 is connected as a receiver device and a microprocessor 15 as an evaluation device, in terms of information technology, and they are configured, together with a data memory 16 which is also connected in terms of information technology to the microprocessor 15 in which instructions for the execution of a disclosed method are stored, to execute the disclosed method.

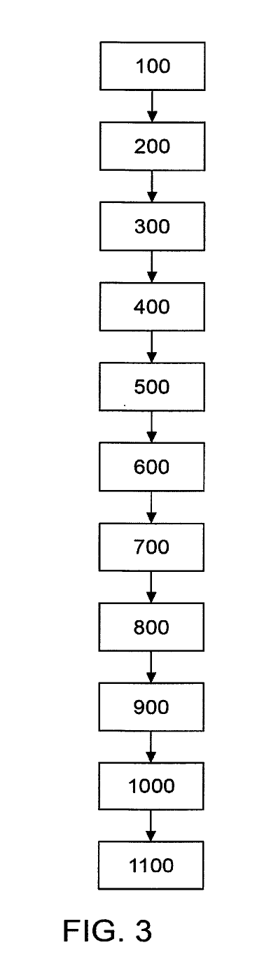

FIG. 3 shows operations of a disclosed method in a flow chart. The method serves to assist a primary user (keeper or owner) in the use of a transportation vehicle by other users. In operation at 100, the primary user combines predefined users of his transportation vehicle into user groups by an app. In operation at 200, the primary user adds contract-related attributes to the user group. In addition, contracted-related attributes which differ from the contract-related attributes of the previously defined user group can be assigned by the user to a second user group. In operation at 300, the primary user's consent to the importing of personal contacts from a personal address book into a circle of potential users of his transportation vehicle is requested. In operation at 400, after the primary user's consent has been given, contact attributes which are defined in the address book are used to assign the contacts to the user groups. In other words, values/parameters which are assigned to the individual contacts or contact groups are used to simplify or carry out their assignment to the above-mentioned user groups in a disclosed application. In operation at 500, a request to rent the transportation vehicle of the primary user is received from a potential user. This can comprise a reception of a wireless communication message to a wireless user terminal (e.g., smartphone, tablet or the like). Subsequently, in operation at 600 a contract-related attribute for the first user is read out on the basis of the membership of the first user of a user group, and in operation at 700 a rental contract between the primary user and the first user is concluded in a digital state using the attribute of the user group. In operation at 800, a transfer of risk from the primary user to the first user is confirmed. As a result, the contractual period of the demand-based renting of the vehicle by the first user starts. In operation at 900, in response to the transfer of risk, a message which characterizes the start of the contractual period of a traffic liability insurance within the scope of a predefined insurance framework contract in the name of the first user to cover damages is sent to a trustee, an app manufacturer and a service provider and logged. In operation at 1000, after use has taken place by the first user, a transfer of risk from the first user to the primary user is confirmed. In response thereto, in operation at 1100 a message which characterizes the end of the contractual period of the traffic liability insurance in the name of the first user to cover damages is sent to the entity which was previously also informed about the start of the contractual period.

### LIST OF REFERENCE NUMBERS

1 Primary user
2 First user
3 Friends
4 Unknown persons
5 Smartphone
6 Contract
7,8,9 Contract-related attributes
10 Passenger car
11 Antenna
12,13,14 User group
15 Microprocessor
16 Data memory
17 Touchscreen
100-1100 Method operations

1. A method for assisting a primary user when a transportation vehicle is used by other users, the method comprising:
receiving a request to rent the transportation vehicle from a first user;
reading out a contract-related attribute for the first user based on a membership of the first user of a user group; and
concluding a digital rental contract between the primary user and the first user by using the attribute of the user group.

2. The method of claim 1, further comprising combining predefined users of transportation vehicle into user groups.

3. The method of claim 1, further comprising adding contract-relative attributes to the user group.

4. The method of claim 1, wherein the contract-related attribute defines:
the validity of traffic liability insurance during the use of the transportation vehicle by the first user and/or
a charge as a contribution by the first user to the costs arising from the use of the transportation vehicle and/or
an obligation or discharge of the first user with respect to the establishment of an agreed transfer state.

5. The method of claim 1, further comprising:
requesting consent of the primary user for the importing of personal contacts into a circle of potential users of his transportation vehicle; and
using contact attributes defined in the address book, for assignment of the contacts to the user group.

6. The method of claim 1, further comprising:
confirming a transfer of risk from the primary user to the first user and
transmitting, in response thereto, a message which starts a contractual period of a traffic liability insurance in the name of the first user to cover damage.

7. The method of claim 6, further comprising:
confirming a transfer of risk from the first user to the primary user; and
transmitting, in response thereto, a message which ends the contractual period of the traffic liability insurance in the name of the first user to cover damage.

8. The method of claim 1, wherein
the first user group is freed, by an attribute, from an obligation to conclude a traffic liability insurance when using the transportation vehicle, and/or
the user group is freed, by an attribute, from an obligation to participate in costs arising during the use of the transportation vehicle.

9. A device for assisting a primary user when transportation vehicle is used by other users, the device comprising:
a receiver device; and
an evaluation unit,
wherein the receiver device receives a request to rent transportation vehicle from a first user, and the evaluation unit is configured:
to read out a contract-related attribute for the first user based on membership of the first user of a user group, and
to conclude a digital rental contract between the primary user and the first user using the contract-related attribute of the user group.

10. The device of claim 9, which performs a method for assisting the primary user when the transportation vehicle is used by other users, the method comprising:
receiving a request to rent the transportation vehicle from a first user;
reading out a contract-related attribute for the first user based on a membership of the first user of a user group; and
concluding a digital rental contract between the primary user and the first user by using the attribute of the user group.

11. The device of claim 10, wherein the method further comprises combining predefined users of transportation vehicle into user groups.

12. The device of claim 10, wherein the method further comprises adding contract-relative attributes to the user group.

13. The device of claim 10, wherein the contract-related attribute defines:
the validity of traffic liability insurance during the use of the transportation vehicle by the first user and/or
a charge as a contribution by the first user to the costs arising from the use of the transportation vehicle and/or
an obligation or discharge of the first user with respect to the establishment of an agreed transfer state.

14. The device of claim 10, wherein the method further comprises:
requesting consent of the primary user for the importing of personal contacts into a circle of potential users of his transportation vehicle; and
using contact attributes defined in the address book, for assignment of the contacts to the user group.

15. The device of claim 10, wherein the method further comprises:
confirming a transfer of risk from the primary user to the first user and
transmitting, in response thereto, a message which starts a contractual period of a traffic liability insurance in the name of the first user to cover damage.

16. The device of claim 10, wherein the method further comprises:
confirming a transfer of risk from the first user to the primary user; and
transmitting, in response thereto, a message which ends the contractual period of the traffic liability insurance in the name of the first user to cover damage.

17. The device of claim 10, wherein the first user group is freed, by an attribute, from an obligation to conclude a traffic liability insurance when using the transportation vehicle, and/or
the user group is freed, by an attribute, from an obligation to participate in costs arising during the use of the transportation vehicle.

18. A transportation vehicle comprising a device for assisting a primary user when transportation vehicle is used by other users, the device comprising:
a receiver device; and
an evaluation unit,
wherein the receiver device receives a request to rent transportation vehicle from a first user, and the evaluation unit is configured:
to read out a contract-related attribute for the first user based on membership of the first user of a user group, and
to conclude a digital rental contract between the primary user and the first user using the contract-related attribute of the user group.
